(19) United States
(12) Patent Application Publication
(10) Pub. No.: US 2023/0275248 A1
(43) Pub. Date: Aug. 31, 2023

(54) STRETCHED, HIGHLY-UNIFORM CATION EXCHANGE MEMBRANES AND PROCESSES OF FORMING SAME

(71) Applicant: THE CHEMOURS COMPANY FC, LLC, WILMINGTON, DE (US)

(72) Inventors: RUIDONG YANG, HOCKESSIN, DE (US); ROBERT HARVEY MOFFETT, LANDENBERG, PA (US); MICHAEL W. RAIFORD, HOCKESSIN, DE (US)

(73) Assignee: THE CHEMOURS COMPANY FC, LLC, WILMINGTON, DE (US)

(21) Appl. No.: 18/012,027

(22) PCT Filed: Jun. 25, 2021
(86) PCT No.: PCT/US2021/039015

§ 371 Date: Dec. 21, 2022

Related U.S. Application Data
(60) Provisional application No. 63/044,052, filed on Jun. 25, 2020.

(51) Int. Cl. H01M 8/1039; H01M 8/18

(52) U.S. Cl. CPC H01M 8/1039; H01M 8/188; H01M 2008/1095

(57) ABSTRACT

A cation exchange membrane includes a film of fluorinated ionomer containing sulfonate groups. The film has a machine direction and a transverse direction perpendicular to the machine direction. The membrane has a water swell in both the machine direction and the transverse direction of less than about 5%. The membrane has a ratio of in-plane conductivity in the machine direction to in-plane conductivity in the transverse direction of about 0.9 to about 1.1. A process makes a cation exchange membrane including a film of fluorinated ionomer containing sulfonate groups. The process includes forming a film of the ionomer. The process also includes biaxially stretching the film in both a machine direction and a transverse direction perpendicular to the machine direction. An electrochemical cell has anode and cathode compartments and includes a cation exchange membrane as a separator between the anode and cathode compartments.

### FIELD OF THE INVENTION

The present invention relates to ion exchange membranes for flow batteries and other electrochemical applications and more particularly to stretched, highly-uniform cation exchange membranes for vanadium redox flow batteries.

### BACKGROUND OF THE INVENTION

A flow battery is a form of rechargeable battery in which electrolyte containing one or more dissolved electroactive species flows through an electrochemical cell that converts chemical energy directly to electricity. Additional electrolyte is stored externally, generally in tanks, and is usually pumped through the cell, or cells, of the reactor, although gravity feed systems are also possible. Flow batteries can be rapidly recharged by replacing the electrolyte liquid while simultaneously recovering the spent material for re-energization.

Three main classes of flow batteries are the redox (reduction-oxidation) flow battery, the hybrid flow battery, and the fuel cell. In the redox flow battery, all of the electroactive components are dissolved or dispersed in the electrolyte. The hybrid flow battery is differentiated in that one or more of the electroactive components is deposited as a solid layer. The redox fuel cell has a conventional flow battery reactor, but the flow battery reactor only operates to produce electricity; it is not electrically recharged. In the latter case, recharge occurs by reduction of the negative electrolyte using a fuel, such as hydrogen, and oxidation of the positive electrolyte using an oxidant, such as air or oxygen.

The vanadium redox flow battery is an example of a redox flow battery, which, in general, involves the use of two redox couple electrolytes separated by an ion exchange membrane. The family of vanadium redox flow batteries includes so-called “All-Vanadium Redox Flow Batteries” (VRB) that employ a V(II)/V(III) couple in the negative half-cell and a V(IV)/V(V) couple in the positive half-cell and “Vanadium Bromide Redox Flow Cells and Flow Batteries” (V/BrRB) that employ the V(II)/V(III) couple in the negative half-cell and a bromide/polyhalide couple in the positive half-cell. In either case, the positive and negative half-cells are separated by a membrane/separator, which prevents cross mixing of the positive and negative electrolytes, whilst allowing transport of ions to complete the circuit during passage of current.

The V(V) ions in the VRB system and the polyhalide ions in the V/BrRB system are highly oxidizing and result in rapid deterioration of most polymeric membranes during use, leading to poor durability. Consequently, potential materials for the membrane/separator have been limited and this remains a main obstacle to commercialization of these types of energy storage systems. Ideally, the membrane should be stable to the acidic environments of electrolytes such as vanadium sulfate (often with a large excess of free sulfuric acid) or vanadium bromide, show good resistance to the highly oxidizing V(V) or polyhalide ions in the charged positive half-cell electrolyte, have a low electrical resistance, have a low permeability to the vanadium ions or polyhalide ions, have a high permeability to charge carrying hydrogen ions, have good mechanical properties, and be low cost. To date, developing a polymer system suitable with respect to this property balance has remained challenging.

Certain perfluorinated ion exchange polymers such as the perfluorosulfonate polymers (for example, Nafion™ polymers, available from The Chemours Company FC, LLC, Wilmington, Del.) show exceptional promise in terms of resistance to acidic environments and highly oxidizing species but show room for further improvement in water and vanadium ion crossover resistance. High vanadium ion crossover results in low coulombic efficiencies, capacity fade, and even self-discharge of the battery, as well as a continuing need to rebalance the electrolyte concentrations in the two half cells. Because of this unwanted capacity fade due to the mix of electroactive ions, the entire battery must be made larger to meet the targeted discharge capacity during times of reduced capacity. Furthermore, the crossover is typically suppressed by using a thicker membrane, which also suppresses proton conductance and significantly increases the cost. This puts flow battery manufacturers at a significant competitive disadvantage relative to manufacturers of other batteries with higher coulombic efficiencies. Clearly, there is a significant incentive to improve the coulombic efficiency of the cell, and the primary way to achieve this is via improved crossover resistance and improved ionic selectivity of the charge-carrying species versus electroactive species.

So et al. (“Hydrophilic Channel Alignment of Perfluoronated Sulfonic-Acid Ionomers for Vanadium Redox Batteries”, ACS Appl. Mater. Interfaces, Vol. 10, pp. 19689-19696, 2018) discloses uniaxial stretching that provides a higher Coulombic efficiency and a longer self-discharge time but also a decreased proton conductivity.

Karpushkin et al. (“Effect of biaxial stretching on the ion-conducting properties of Nafion membranes”, Mendeleev Commun., Vol. 26, pp. 117-118, 2016) discloses biaxial stretching at various draw ratios leading to a reduced vanadium permeability but also a decreased self-discharge time.

There is a need for ion exchange membranes having a higher tensile strength, a reduced wet swell, a reduced vanadium crossover, an improved energy efficiency, a reduced self-discharge rate, and/or an increased ionic selectivity.

### BRIEF DESCRIPTION OF THE INVENTION

In an exemplary embodiment, a cation exchange membrane includes a film of fluorinated ionomer containing sulfonate groups. The film has a machine direction and a transverse direction perpendicular to the machine direction. The membrane has a water swell in both the machine direction and the transverse direction of less than about 5%. The membrane has a ratio of in-plane conductivity in the machine direction to in-plane conductivity in the transverse direction in the range of about 0.9 to about 1.1.

In another exemplary embodiment, a process makes a cation exchange membrane including a film of fluorinated ionomer containing sulfonate groups. The process includes forming a film of the ionomer. The process also includes biaxially stretching the film in both a machine direction and a transverse direction perpendicular to the machine direction to cause the membrane to have a water swell in both the machine direction and the transverse direction of less than about 5% and to cause the membrane to have a ratio of in-plane conductivity in the machine direction to in-plane conductivity in the transverse direction in the range of about 0.9 to about 1.1.

In yet another exemplary embodiment, an electrochemical cell has anode and cathode compartments and includes a cation exchange membrane as a separator between the anode and cathode compartments. The membrane includes a film of fluorinated ionomer containing sulfonate groups. The film has a machine direction and a transverse direction perpendicular to the machine direction. The membrane has a water swell in both the machine direction and the transverse direction of less than about 5%, and the membrane has a ratio of in-plane conductivity in the machine direction to in-plane conductivity in the transverse direction in the range of about 0.9 to about 1.1.

Other features and advantages of the present invention will be apparent from the following more detailed description of the preferred embodiments, taken in conjunction with the accompanying drawings which illustrate, by way of example, the principles of the invention.

### BRIEF DESCRIPTION OF THE DRAWING

FIG. 1 is a schematic view of an all-vanadium redox flow battery in an embodiment of the present disclosure.

### DETAILED DESCRIPTION OF THE INVENTION

Provided are stretched ion exchange membranes having a high tensile strength, a low wet swell, a low vanadium crossover, a high energy efficiency, a low self-discharge rate, a high ionic selectivity, or combinations thereof.

In exemplary embodiments, the film of the stretched ion exchange membrane is biaxially stretched in predetermined stretching ratios in both a machine direction and a transverse direction to provide the stretched ion exchange membrane with a water swell in both the machine direction and the transverse direction of less than about 5% and with a ratio of in-plane conductivity in the machine direction to in-plane conductivity in the transverse direction in the range of about 0.9 to about 1.1.

As used herein, machine direction refers to the in-plane direction of a film parallel to a direction of travel or wind-up on a roll of the membrane during manufacture of the film.

As used herein, transverse direction refers to the in-plane direction of a film perpendicular to the machine direction.

As used herein, stretching ratio refers to the ratio of the stretched length of the film to the unstretched length of the film.

As used herein, in-plane conductivity refers to the proton conductivity of a film in the plane of the film.

As used herein, through-plane conductivity refers to the proton conductivity of a film in the direction perpendicular to the plane of the film.

As used herein, vanadyl ion (VO²⁺) permeability refers to the permeability of VO²⁺ vanadyl ions through a film in the direction perpendicular to the plane of the film.

As used herein, ionic selectivity refers to the permeability of a proton relative to a vanadyl ion through a film in the direction perpendicular to the plane of the film, expressed as through-plane conductivity divided by vanadyl ion permeability.

As used herein, tensile strength refers to the resistance of a film to breakage under tension in a predetermined direction calculated as the maximum load divided by the minimum cross-sectional area prior to breakage.

As used herein, water swell refers to the percentage change in length of a film in a predetermined in-plane direction from conditions of 50% relative humidity at room temperature to immediately after being placed in boiling water for one hour.

In exemplary embodiments, the film includes fluorinated ionomer containing sulfonate groups. In some embodiments, the membrane includes a hydrolyzed melt-extruded film of the ionomer. In some embodiments, the membrane includes a cast film of the ionomer.

The term “sulfonate groups” is intended to refer to either sulfonic acid groups or salts of sulfonic acid, preferably alkali metal or ammonium salts. Preferred functional groups are represented by the formula —SO₃X wherein X is H, Li, Na, K or N(R¹)(R²)(R³)(R⁴) and R¹, R², R³, and R⁴ are the same or different and are H, CH₃ or C₂H₅. A class of preferred fluorinated ionomers containing sulfonate groups for use in the present films include a highly fluorinated, most preferably perfluorinated, carbon backbone and the side chain is represented by the formula —(O—CF₂CFR^{f})ₐ—O— CF₂CFR′^{f}SO₃X, where R^{f} and R′^{f} are independently selected from F, Cl or a perfluorinated alkyl group having 1 to 10 carbon atoms, a=0, 1 or 2, and X is H, Li, Na, K or N(R¹)(R²)(R³)(R⁴) and R¹, R², R³, and R⁴ are the same or different and are H, CH₃ or C₂H₅. Preferred fluorinated ionomers containing sulfonate groups may include, for example, polymers disclosed in U.S. Pat. No. 3,282,875, in U.S. Pat. No. 4,358,545, or in U.S. Pat. No. 4,940,525. For use in vanadium redox flow batteries and fuel cells, fluorinated ionomer in the membrane is typically employed in the proton form, i.e., X is H.

One preferred fluorinated ionomer containing sulfonate groups includes a perfluorocarbon backbone and a side chain represented by the formula —O—CF₂CF(CF₃)—O—CF₂CF₂SO₃X, where X is as defined above. When X is H, the side chain is —O—CF₂CF(CF₃)—O—CF₂CF₂SO₃H. Fluorinated ionomers containing sulfonate groups of this type are disclosed in U.S. Pat. No. 3,282,875 and may be made by copolymerization of tetrafluoroethylene (TFE) and the perfluorinated vinyl ether CF₂═CF—O—CF₂CF(CF₃)—O—CF₂CF₂SO₂F, perfluoro(3,6-dioxa-4-methyl-7-octenesulfonyl fluoride) (PSEPVE), followed by conversion to sulfonate groups by hydrolysis of the sulfonyl fluoride groups and conversion to the proton form if desired for the particular application.

One preferred fluorinated ionomer containing sulfonate groups of the type disclosed in U.S. Pat. Nos. 4,358,545 and 4,940,525 has the side chain —O—CF₂CF₂SO₃X, where X is as defined above. This fluorinated ionomer containing sulfonate groups may be made by copolymerization of tetrafluoroethylene (TFE) and the perfluorinated vinyl ether CF₂═CF—O—CF₂CF₂SO₂F, perfluoro(3-oxa-4-pentenesulfonyl fluoride) (PFSVE), followed by hydrolysis and conversion to the proton form if desired for the particular application. When X is H, the side chain is —O—CF₂CF₂SO₃H.

In exemplary embodiments, the fluorinated ionomer containing sulfonate groups is of the type available under the trade name of Nafion™ (The Chemours Company FC, LLC, Wilmington, Del.).

In exemplary embodiments, the fluorinated ionomer film has been biaxially stretched to improve the in-plane conductivity uniformity of the fluorinated ionomer film in the biaxial directions such that a membrane of the film has improved ionic selectivity and a reduced self-discharge relative to a fluorinated ionomer film that has not been biaxially stretched.

In exemplary embodiments, the membrane has an ionic selectivity, in units of (mS cm⁻¹)/(10⁻⁶ cm² min⁻¹), of at least about 50, alternatively at least about 60, alternatively at least about 70, alternatively at least about 80, alternatively at least about 90, alternatively at least about 100, alternatively at least about 110, or any value, range, or sub-range therebetween.

In exemplary embodiments, the membrane has an ion exchange ratio (IXR) in the range of about 7 to about 25, alternatively about 10 to about 25, alternatively about 9 to about 15, alternatively about 11 to about 19, alternatively about 11 to about 14, or any value, range, or sub-range therebetween. As used herein, IXR refers to the number of carbon atoms in the ionomer backbone in relation to the number of cation exchange groups.

In exemplary embodiments, the membrane is made by the copolymerization of TFE and PSEPVE followed by hydrolysis and ion exchange into proton form. Such membranes possesses a side chain represented by the formula —O—CF₂CF(CF₃)—O—CF₂CF₂SO₃H and have an equivalent weight (EW) in the range of about 600 to about 1600, alternatively about 700 to about 1600, alternatively about 850 to about 1430, alternatively about 850 to about 1200, alternatively about 900 to about 1100, or any value, range, or sub-range therebetween. As used herein, EW refers to the weight of the ionomer in proton form required to neutralize one equivalent of NaOH.

In exemplary embodiments, the membrane is made by the copolymer of TFE and PFSVE, followed by hydrolysis and ion exchange into proton form. Such membrane possesses a side chain represented by the formula —O—CF₂CF₂SO₃H, and has an EW in the range of about 400 to about 1600, alternatively about 500 to about 1430, alternatively about 600 to about 1200, alternatively about 760 to about 1100, alternatively about 850 to about 1100, or any value, range, or sub-range therebetween. Such ionomers may be referred to as short side chain ionomers.

IXR for fluoroionomer with the side chain —O—CF₂—CF(CF₃)—O—CF₂—CF₂—SO₃H, i.e., produced from a copolymer of TFE and PSEPVE, can be related to EW using the following formula: 50 IXR+344=EW. IXR for fluoroionomer with the side chain —O—CF₂CF₂SO₃H, i.e., produced from a copolymer of TFE and PFSVE, can be related to equivalent weight using the following formula: 50 IXR+178=EW.

In exemplary embodiments, the membrane has a thickness in the range of about 10 μm to about 200 μm, alternatively about 15 μm to about 100 μm, alternatively about 20 μm to about 50 μm, or any value, range, or sub-range therebetween.

In exemplary embodiments, a process for making a cation exchange membrane includes forming a film of a fluorinated ionomer containing sulfonate groups and biaxially stretching the film in both a machine direction and a transverse direction perpendicular to the machine direction. The biaxial stretching causes the membrane to have a water swell in both the machine direction and the transverse direction of less than a predetermined value and causes the membrane to have a ratio of in-plane conductivity in the machine direction to in-plane conductivity in the transverse direction in a predetermined range.

In exemplary embodiments, the forming includes extruding the ionomer in its sulfonyl fluoride form into a precursor film and subsequently hydrolyzing the sulfonyl fluoride groups in the ionomer in the precursor film to produce a hydrolyzed melt-extruded film.

In exemplary embodiments, the ionomer film is in the proton form during the biaxial stretching.

In exemplary embodiments, the biaxial stretching includes sequentially stretching first in the machine direction and then in the transverse direction.

In some embodiments, a film-stretching machine stretches the film in the machine direction. The film is fed into the machine at a predetermined rate, such as, for example, 5 feet per minute. Stretching is accomplished by passing the film over two pre-heating rolls for heating the film followed by a slow roll and fast roll for stretching the film. The slow roll and the fast roll provide a predetermined stretching ratio. The film may then pass over an annealing roll followed by a cooling roll. In some embodiments, the temperatures of the rolls are about 150° F. (about 66° C.) for the first pre-heat roll, about 230° F. (about 110° C.) for the second pre-heat roll and the slow roll, about 225° F. (about 107° C.) for the fast roll, about 180° F. (about 82° C.) for the annealing roll, and about 82° F. (about 28° C.) for the cooling roll.

In some embodiments, the film is stretched in the transverse direction by a tenter process after stretching in the machine direction. The film is fed into a tenter oven and securely gripped by clips on both edges. The tenter oven contains three sequential regions: preheating, stretching, and annealing. The temperature in each region is separately controlled, such as, for example, at about 300° F. (about 149° C.) for the preheating region, the stretching oven at about 290° F. (about 143° C.) for the stretching region, and about 285° F. (about 141° C.) for the annealing region. The transverse stretching occurs over a predetermined distance at a predetermined stretching ratio, such as, for example, a distance of about 9.5 feet and a stretching ratio of about 2.5. The film was allowed to relax by a predetermined amount, such as, for example, about 0.01%, in the annealing oven. After the annealing, the edges of the film may be trimmed and the film may be wound onto a cardboard core.

In some embodiments, the biaxial stretching occurs simultaneously in the machine direction and in the transverse direction.

In exemplary embodiments, the biaxial stretching causes the membrane to have a water swell in both the machine direction and the transverse direction of less than about 5%, alternatively less than about 4%, alternatively less than about 3%, alternatively less than about 2%, alternatively less than about 1%, alternatively less than about 0%, alternatively about −2% to about −6%, or any value, range, or sub-range therebetween.

In exemplary embodiments, the biaxial stretching causes the membrane to have a ratio of in-plane conductivity in the machine direction to in-plane conductivity in the transverse direction in the range of about 0.8 to about 1.2, alternatively about 0.9 to about 1.1, alternatively about 0.95 to about 1.05, alternatively about 0.96 to about 1.04, alternatively about 0.98 to about 1.02, alternatively about 0.99 to about 1.01, or any value, range, or sub-range therebetween.

In exemplary embodiments, the rate of biaxial stretching is in the range of about 1% per second to about 50% per second, alternatively about 1% per second to about 40% per second, alternatively about 1% per second to about 30% per second, alternatively about 1% per second to about 20% per second, alternatively about 5% per second to about 20% per second, alternatively about 1% per second to about 10% per second, alternatively about 10% per second to about 20% per second, alternatively about 20% per second to about 30% per second, or any value, range, or sub-range therebetween.

In exemplary embodiments, the main chain of the fluorinated ionomer containing sulfonate groups has a glass transition temperature in the range of about 100° C. to about 125° C., and the side chains have a glass transition temperature in the range of about 190° C. to about 245° C. In exemplary embodiments, the biaxial stretching occurs at a temperature, with respect to the glass transition temperature of the main chain of the ionomer film, greater than about 20° C. below, alternatively greater than about 10° C. below, alternatively greater than the glass transition temperature of the main chain of the ionomer film, or any value, range, or sub-range therebetween. In exemplary embodiments, the biaxial stretching occurs at a temperature in the range of about 70° C. to about 250° C., alternatively about 75° C. to about 150° C., alternatively about 80° C. to about 140° C., or any value, range, or sub-range therebetween.

In exemplary embodiments, the biaxial stretching includes stretching in both the machine direction and the transverse direction each at a stretching ratio in the range of about 1.1 to about 5, alternatively about 1.2 to about 2, alternatively about 1.2 to about 2.5, alternatively about 2 to about 5, alternatively about 2 to about 3.5, alternatively about 2 to about 3, alternatively about 2 to about 2.5, alternatively about 1.7 to about 3, alternatively about 1.7 to about 2, or any value, range, or sub-range therebetween.

In exemplary embodiments, the process further includes annealing the film after the biaxial stretching. The annealing includes heating the film for a period of about 5 seconds to about 30 minutes to a temperature in the range of about 0° C. to about 300° C., alternatively about 25° C. to about 200° C., alternatively about 50° C. to about 200° C., alternatively about 100° C. to about 190° C., alternatively about 125° C. to about 160° C., or any value, range, or sub-range therebetween, while providing tension sufficient to hold the film in a stretched condition. In some embodiments, the annealing further includes partially releasing the tension in the transverse direction such that the width of the film in the transverse direction decreases by no more than 10%. Although the stretched film without annealing may have good performance relative to an equivalent non-stretched film, the annealing was found to provide even better performance in some embodiments.

Films and membranes of the present disclosure may be used in any of a number of different applications, including, but not limited to, electrochemical cells, flow batteries, vanadium redox flow batteries, water electrolysis, direct methanol fuel cells, hydrogen fuel cells, or carbon dioxide electrolysis.

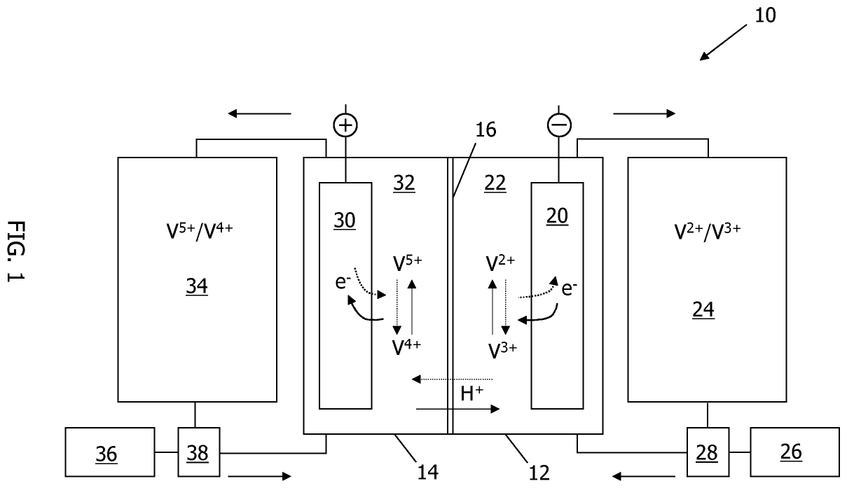

FIG. 1 shows an electrochemical cell 10 having an anode compartment 12 and a cathode compartment 14 and including a cation exchange membrane 16 as disclosed herein as a separator between the anode compartment 12 and the cathode compartment 14. In some embodiments, the electrochemical cell 10 is a flow battery. In some embodiments, the flow battery is a vanadium redox flow battery or an all vanadium redox flow battery.

The anode compartment 12 contains the anode 20 and anolyte 22. Additional anolyte 22 is stored in an anolyte tank 24 and may be supplied to the anode compartment 12 by way of an anolyte pump 26, with an anolyte valve 28 controlling the direction of flow.

The cathode compartment 14 contains the cathode 30 and catholyte 32. Additional catholyte 32 is stored in a catholyte tank 34 and may be supplied to the cathode compartment 14 by way of a catholyte pump 36, with a catholyte valve 38 controlling the direction of flow.

### EXAMPLES

The invention is illustrated in the following examples which do not limit the scope of the invention as described in the claims.

### Test Methods

### Determination of In-Plane Conductivity

For the determination of the in-plane conductivity (IPC), MD and TD were marked on the film. The film was then soaked in a boiling water bath for 1 hour, followed by immediate transfer into deionized water to form a membrane. The membrane was then assembled into a customized in-plane conductivity cell with the desired measuring direction being perpendicular to the direction of the platinum wires. The in-place conductivity cell containing the membrane was kept immersed in the deionized water for the whole measurement. The electrical resistance of the membrane, R_{MD} or R_{TD} (Ω), was measured via a linear sweep voltammetry (LSV) technique by a four-electrode setup on a BioLogic potentiostat (BioLogic Science Instruments, Seyssinet-Pariset, France).

The MD or TD conductivity of the membrane, σ_{MD} or σ_{TD} (mS/cm), was thus calculated using Equation 1:

$$σ = \frac{L}{W \times T \times R} \qquad ( 1 )$$

where L is the distance between platinum voltage wires, W is the width of the membrane in the direction parallel to the platinum wire, T is the thickness of the membrane, and R is the measured resistivity of the membrane.

### Determination of Through-Plane Conductivity

For the determination of the through-plane (proton) conductivity, the film was soaked in a 60° C. deionized water bath for 6 hours to form a membrane. The membrane was then immediately transferred to a covered container filled with the testing electrolyte (2.5 M sulfuric acid) and allowed to soak overnight. A customized H-cell was utilized for the measurement. The electric resistance was measured via an electrochemical impedance spectroscopy (EIS) technique by a four-electrode setup on a potentiostat (BioLogic).

The cell was first assembled without a membrane and filled with 2.5 M sulfuric acid to measure the non-membrane ohmic resistance or the cell resistance, R_{cell} (Ω). The total resistance, Rₜₒₜₐₗ (Ω), was measured with the membrane affixed in the H-Cell, with equal amounts of test solution added to both sides of the assembled cell. The resistance of the membrane, R_{membrane} (Ω) is the difference between the total resistance and the cell resistance.

The through-plane conductivity of the membrane, σ_{T} (mS/cm), was calculated using Equation 2:

$${σ}_{T} = \frac{T}{A \times {R}_{membrane}} \qquad ( 2 )$$

where T is the thickness of the membrane, and A is the tested area of the membrane.

### Determination of Vanadyl Ion Permeability

For the determination of the vanadyl ion permeability, the film was soaked in a 60° C. deionized water bath for 6 hours to form a membrane. The membrane was then immediately transferred to a covered container filled with the testing electrolyte (1.5 M MgSO₄ in 2.5 M sulfuric acid) and allowed to soak overnight. A customized H-cell was utilized for the measurement. One side of the cell was filled with 1.5 M MgSO₄ in 2.5 M sulfuric acid electrolyte solution, while the same volume of 1.5 M VOSO₄ in 2.5 M sulfuric acid electrolyte solution was filled on the counter compartment of the cell. A UV-Vis probe was inserted to the MgSO₄ electrolyte side to monitor the intensity of the absorbing peak at 760 nm, which is associated with the VO²⁺ ion diffused from the VOSO₄ electrolyte. The vanadyl ion permeability, P_{VO}²⁺, was calculated using Equation 3:

$${P}_{{VO}^{2 +}} = \frac{V \times T}{- 2 A \times t} ln [ 1 - 2 \frac{{C}_{t}}{{C}_{{VO}^{2 +}}} ] \qquad ( 3 )$$

where V is the electrolyte volume on each side in cm³, T is the membrane thickness in cm, A is the tested area of the membrane in cm², t is the sampling time in min, Ct is the concentration of the VO²⁺ at sampling time t, and C_{VO}²⁺ is the initial vanadyl concentration. The vanadyl ion permeability is in the units of 10⁻⁶ cm²/min.

### Determination of Ionic Selectivity

The ionic selectivity was calculated from the determined values for the through-plane conductivity of the membrane and the vanadyl ion permeability using Equation 4:

$$ionic selectivity = \frac{{σ}_{T}}{{P}_{{VO}^{2 +}}} \qquad ( 4 )$$

where the ionic selectivity is in the units of “(mS cm⁻¹)/(10⁻⁶ cm² min⁻¹)” or “10⁶ mS min/cm³”.

### Determination of Tensile Strength

For the determination of the tensile strength, the film was conditioned at 50% relative humidity (RH) and 22° C. for at least 40 hours. The tensile strength was then measured following the international standard, ASTM D882. Tensile strength was calculated by dividing the maximum load by the original minimum cross-sectional area of the membrane.

### Determination of Water Swell

For the determination of the water swell, the film was cut into pieces measuring 5 cm×5 cm. Marks were made on the film in the MD and the TD with a distance of 4 cm between the marks, then the film was transferred into a 50% RH chamber overnight. The film was then placed into boiling water for one hour. The distances between the marks on the film were then immediately measured as the swell distance. The water swell in each direction was calculated as a percentage based the difference between the swell distance and the original distance (4 cm) divided by the original distance.

### INVENTIVE EXAMPLES

For each of Inventive Example 1, Inventive Example 2, and Inventive Example 3, a Nafion™ N1110 film (The Chemours Company FC, LLC, Wilmington, Del.) having a thickness of 254 microns was used as the starting film of fluorinated ionomer containing sulfonate groups. The extruded film is a TFE/PSEPVE copolymer in the proton form with an EW of about 1000. The film had been previously hydrolyzed and converted to its proton form by the manufacturer. A sequential film-stretching machine was utilized to stretch the film. The film was fed into the machine at a rate of 5 feet per minute. Machine direction (MD) stretching was accomplished by passing the film over two pre-heating rolls followed by a slow roll and fast roll for the stretching. The film then went over an annealing roll followed by a cooling roll. The MD stretching ratio was maintained at the value indicated in Table 1. The two pre-heat rolls were maintained at a temperature of 150° F. and 230° F., respectively. The temperature of the slow roll was set at 230° F., while the fast roll was at 225° F. Temperatures for the annealing and cooling rolls for the machine direction stretching were 180° F. and 82° F., respectively.

After the MD stretching process, the film was stretched in the transverse direction (TD) using a tenter process. The film was fed into the tenter oven and securely gripped by clips on both edges. The tenter oven contained three segments: preheating, stretching, and annealing. The temperature in each segment was separately controlled. The preheating oven was maintained at 300° F., the stretching oven at 290° F., and the annealing oven at 285° F. The TD stretching occurred over a distance of 9.5 feet. The TD stretching ratio was maintained at 2.5. The film was allowed to relax by 0.01% in the annealing oven. After the annealing step, the edges of the film were trimmed and the film was then wound onto a cardboard core as Inventive Example 1, Inventive Example 2, and Inventive Example 3.

Inventive Example 4, Inventive Example 5, Inventive Example 6, and Inventive Example 7 were formed in the same manner as Inventive Example 1, Inventive Example 2, and Inventive Example 3. The starting extruded film of these comparative examples is Nafion™ N1110 film, a TFE/PSEPVE copolymer in the proton form with an EW of about 1000 and a thickness of about 254 microns. The film had been previously hydrolyzed to its proton form by the manufacturer.

The inventive examples were tested for in-plane conductivity, through-plane (proton) conductivity, vanadyl ion permeability, ionic selectivity, tensile strength, and water swell.

The resulting values for the in-plane conductivity in the machine direction, the in-plane conductivity in the transverse direction, the ratio of in-plane conductivity in the machine direction and the in-plane conductivity in the transverse direction, the proton conductivity, the vanadyl ion permeability, the ionic selectivity, the tensile strength in the machine direction, the tensile strength in the transverse direction, the water swell in the machine direction, and the water swell in the transverse direction are shown in Table 1 for the inventive examples. Negative water swell values indicate that the film decreased or contracted in length in the predetermined direction during the boiling conditions rather than swelling. N/D indicates the parameter was not determined, and standard deviations are provided for certain measurements.

TABLE 1
Properties of Inventive Examples

| | Inventive Example # | | | | | | |
|---|---|---|---|---|---|---|---|
| | 1 | 2 | 3 | 4 | 5 | 6 | 7 |
| MD stretching ratio | 2.2 | 2.1 | 2.0 | 2.5 | 2.4 | 2.25 | 2.4 |
| TD stretching ratio | 2.5 | 2.5 | 2.5 | 2.5 | 2.4 | 2.25 | 2.4 |
| MD IPC (mS/cm) | 103.9 ± 6.7 | 97.8 ± 1.4 | 102.4 ± 6.3 | 113.6 ± 1.9 | 103.2 ± 2.0 | 100.6 ± 1.4 | 114.0 ± 1.4 |
| TD IPC (mS/cm) | 104.4 ± 5.8 | 96.6 ± 2.1 | 102.6 ± 6.3 | 108.4 ± 2.4 | 98.2 ± 1.4 | 95.0 ± 2.4 | 110.0 ± 0.7 |
| MD:TD IPC ratio | 0.995 | 1.012 | 0.999 | 1.048 | 1.051 | 1.058 | 1.036 |
| Proton conductivity | 81 ± 6.9 | 74.4 ± 1.9 | 77.1 ± 2.6 | 67.5 ± 2.3 | 72.7 ± 2.5 | N/D | 71.1 ± 3.9 |
| (mS/cm) | | | | | | | |
| VO²⁺ permeability | 0.67 | 0.67 | 0.62 | 0.763 | 0.825 | N/D | 0.819 |
| (×10⁻⁶ cm²/min) | | | | | | | |
| Ionic selectivity | 121 | 111 | 124 | 88 | 88 | N/D | 87 |
| MD tensile strength | 73.4 ± 6.1 | 68.4 ± 6.0 | 70.7 ± 3.4 | 71.4 ± 20.5 | 76.5 ± 13.6 | 74.4 ± 3.2 | 78 ± 21.7 |
| (MPa) | | | | | | | |
| TD tensile strength | 71.7 ± 3.5 | 81.3 ± 1.7 | 79.2 ± 3.8 | 70.0 ± 5.8 | 66.1 ± 9.8 | 56.8 ± 12.3 | 64.6 ± 24 |
| (MPa) | | | | | | | |
| MD water swell | −3.8 ± 1.1 | −2.7 ± 0.8 | −3.9 ± 0.6 | −5.1 ± 1.4 | −7.2 ± 1.1 | −6.1 ± 0.8 | −8.9 ± 1.4 |
| (%) | | | | | | | |
| TD water swell (%) | −5.6 ± 0.6 | −5.9 ± 0.8 | −4.9 ± 1.0 | 0.6 ± 0.8 | −2.0 ± 1.7 | −2.3 ± 1.7 | −4.6 ± 1.1 |

### COMPARATIVE EXAMPLES

Comparative Example 1 was a cast and unstretched film of Nafion™ NR212 having a thickness of about 50 microns. The film had been cast from a dispersion of hydrolyzed TFE/PSEPVE copolymer in proton form with an EW of about 1000.

Comparative Example 2 and Comparative Example 3 were formed in the same manner as the inventive examples, with the MD stretching ratio and the TD stretching ratio being as indicated in Table 2. The starting extruded film of these comparative examples is Nafion™ N1110 film, a TFE/PSEPVE copolymer in the proton form with an EW of about 1000 and a thickness of about 254 microns. The film had been previously hydrolyzed to its proton form by the manufacturer.

The comparative examples were tested for in-plane conductivity, through-plane (proton) conductivity, vanadyl ion permeability, ionic selectivity, tensile strength, and water swell.

The resulting values for the in-plane conductivity in the machine direction, the in-plane conductivity in the transverse direction, the ratio of in-plane conductivity in the machine direction and the in-plane conductivity in the transverse direction, the proton conductivity, the vanadyl ion permeability, the ionic selectivity, the tensile strength in the machine direction, the tensile strength in the transverse direction, the water swell in the machine direction, and the water swell in the transverse direction are shown in Table 2 for the comparative examples. N/A indicates the parameter was not applicable, N/D indicates the parameter was not determined, and standard deviations are provided for certain measurements.

TABLE 2
Properties of Comparative Examples

| Comparative Example # | 1 | 2 | 3 |
|---|---|---|---|
| MD stretching ratio | N/A | 2.0 | N/A |
| TD stretching ratio | N/A | N/A | 2.0 |
| MD IPC (mS/cm) | 112.0 ± 1.5 | 101.5 ± 1.5 | 94.1 ± 3.0 |
| TD IPC (mS/cm) | 112.2 ± 1.5 | 94.4 ± 1.0 | 100.1 ± 1.5 |
| MD:TD IPC ratio | 0.998 | 1.076 | 0.940 |
| Proton conductivity | 87 ± 20 | 48 ± 12 | 62 ± 6.9 |
| (mS/cm) | | | |
| VO²⁺ permeability | 1.6 | 1.2 | 0.97 |
| (×10⁻⁶ cm²/min) | | | |
| Ionic selectivity | 54 | 40 | 64 |
| MD tensile strength (MPa) | 25-30 | 50.7 ± 13.3 | 35.8 ± 0.6 |
| TD tensile strength (MPa) | 25-30 | 33.9 ± 4.3 | 64.7 ± 3.2 |
| MD water swell (%) | 20.5 | −8.9 ± 0.6 | 22.2 ± 6.0 |
| TD water swell (%) | 15.6 | 21.1 ± 0.5 | −1.2 ± 2.3 |

Relative to the comparative examples, the inventive examples possessed a ratio of in-plane conductivity in the machine direction to in-plane conductivity in the transverse direction closer to 1, a reduced vanadyl permeability, and/or a higher ionic selectivity.

All above-mentioned references are hereby incorporated by reference herein.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A cation exchange membrane comprising a film of fluorinated ionomer containing sulfonate groups, said film having a machine direction and a transverse direction perpendicular to said machine direction, said membrane having a water swell in both the machine direction and the transverse direction of less than about 5%, and said membrane having a ratio of in-plane conductivity in the machine direction to in-plane conductivity in the transverse direction in the range of about 0.9 to about 1.1.

2. The cation exchange membrane of claim 1 having an ionic (proton/VO²⁺) selectivity of at least about 60 (mS cm⁻¹)/(10⁻⁶ cm² min⁻¹).

3. The cation exchange membrane of claim 1 having an ion exchange ratio in the range of about 7 to about 25.

4. The cation exchange membrane of claim 3, said ion exchange ratio being in the range of about 9 to about 15.

5. The cation exchange membrane of claim 1 having a thickness in the range of about 10 μm to about 200 μm.

6. A process for making a cation exchange membrane comprising a film of fluorinated ionomer containing sulfonate groups, said process comprising:
forming a film of said ionomer; and
biaxially stretching said film in both a machine direction and a transverse direction perpendicular to said machine direction to cause said membrane have a water swell in both the machine direction and the transverse direction of less than about 5%, and to cause said membrane to have a ratio of in-plane conductivity in the machine direction to in-plane conductivity in the transverse direction in the range of about 0.9 to about 1.1.

7. The process of claim 6, wherein said biaxial stretching is carried out at a rate in the range of about 1%/sec to about 30%/sec in the machine direction and in the transverse direction.

8. The process of claim 6, wherein said film is heated to a temperature not lower than about 20° C. below the glass transition temperature of the ionomer during said biaxial stretching.

9. The process of claim 6 further comprising heating said film to a temperature in the range of about 70° C. to about 250° C. during said biaxial stretching.

10. The process of claim 6, wherein said film is stretched at a ratio of 1.2 to about 5 in both the machine direction and the transverse direction.

11. The process of claim 6, wherein said forming of said film comprises extruding said ionomer in sulfonyl fluoride form into a precursor film and subsequently hydrolyzing said sulfonyl fluoride groups in said ionomer in said precursor film to produce a hydrolyzed melt-extruded film.

12. The process of claim 11, wherein said machine direction is the direction that said film is extruded into a precursor film.

13. The process of claim 6, wherein said ionomer film is in the proton form during said biaxial stretching.

14. The process of claim 6, wherein said ionomer film is sequentially stretched with the film being stretched first in the machine direction and then in the transverse direction.

15. The process of claim 6, wherein said process further comprises annealing said film after biaxial stretching by heating said film for a period of about 5 seconds to about 30 minutes to a temperature in the range of about 85° C. to about 200° C. while providing sufficient tension on said film to hold said film in a stretched condition.

16. The process of claim 15, wherein said annealing comprises partially releasing the tension in the transverse direction so that the width of the film in the transverse direction decreases by no more than about 10%.

17. An electrochemical cell having anode and cathode compartments and comprising a cation exchange membrane as a separator between said anode and cathode compartments, said membrane comprising a film of fluorinated ionomer containing sulfonate groups, said film having a machine direction and a transverse direction perpendicular to said machine direction, said membrane having a water swell in both the machine direction and the transverse direction of less than about 5%, and said membrane having a ratio of in-plane conductivity in the machine direction to in-plane conductivity in the transverse direction in the range of about 0.9 to about 1.1.

18. The electrochemical cell of claim 17, wherein said electrochemical cell is a flow battery.

19. The electrochemical cell of claim 18, wherein said flow battery is an all vanadium redox flow battery.

20. The electrochemical cell of claim 19, wherein said membrane has an ionic (proton/VO²⁺) selectivity of at least about 60 (mS cm⁻¹)/(10⁻⁶ cm²
